(19) United States
(12) Patent Application Publication
(10) Pub. No.: US 2023/0003578 A1
(43) Pub. Date: Jan. 5, 2023

(54) COLOR MEASUREMENT

(71) Applicant: ams Sensors Germany GmbH, Jena (DE)

(72) Inventor: Gunter SIESS, Kraftsdorf (DE)

(21) Appl. No.: 17/781,711

(22) PCT Filed: Dec. 2, 2020
(86) PCT No.: PCT/EP2020/084302

§ 371 Date: Jun. 2, 2022

Related U.S. Application Data
(60) Provisional application No. 62/943,038, filed on Dec. 3, 2019.

(51) Int. Cl. G01J 3/28; G01S 17/08; H04N 5/232

(52) U.S. Cl. CPC G01J 3/28; G01S 17/08; H04N 5/232945

(57) ABSTRACT

A method of measuring the color of a surface may include a device positioned above the surface. The device may include an optical sensor and a display screen. The optical sensor measures visible light level reflected from the surface in a plurality of spectral channels. A plurality of patterns are sequentially displayed on the display screen. The optical sensor is used to measure light reflected by the surface during display of each pattern. A value is determined for the distance from the optical sensor to the illuminated region for a first local maximum of intensity of the measured light reflected by the surface. A location in a color space corresponding to a color of the surface or a reflectance spectrum of the surface is determined based on the visible light level in each spectral channel for the value of the distance corresponding to the first local maximum.

### CROSS-REFERENCE TO RELATED APPLICATIONS

The present application is a national stage entry according to 35 U.S.C. § 371 of PCT application No.: PCT/EP2020/084302 filed on Dec. 2, 2020, which claims priority to U.S. Provisional Patent Application No. 62/943,038 filed on Dec. 3, 2019; both of which are incorporated herein by reference in their entirety and for all purposes.

### TECHNICAL FIELD

This specification relates to methods and systems for measuring the color of a surface.

### BACKGROUND

In general, the color of a surface is measured by measuring the light reflected from the surface over a number of bands, and transforming these measurements into a “color space”. A color space is a model which assigns colors to a framework for ease of reference. Color spaces may assign specific names and numbers to each color (e.g. the Pantone™ collection), or they may plot colors in a (usually 3-dimensional) phase space, such as the RGB space commonly used for computer displays, or the CIE color space.

Standards for color measurement define that the measurement should be taken in one of two geometries—0°/45°, as shown in FIG. 1A or 45°/0°, as shown in FIG. 1B. In each case, a light source 101 illuminates a point 102 on a surface 103, and the reflection from the point 102 is received by a detector 104. The first number indicates the angle between a first line perpendicular to the surface and passing through the point 102, and a second line connecting the light source 101 and the point 102 (relative to a direction perpendicular to the surface). The second number indicates the angle between the first line and a third line connecting the point 102 to the detector 104. In practical examples, the source 101 may not be a point source, the “point” 102 may be more spread out, and the detector 104 may also detect light reflected from a region around the point 102.

This measurement geometry is chosen to maximize the diffuse reflection of light from the light source to the detector, and to ensure that there are no contributions to the signal from specular reflection.

For the measurement of reflectance, a symmetrical geometry is used, such that the specular reflection of the light source from the surface is picked up by the detector. In addition, the ratio of intensity of the diffuse and specular reflection is important, so that the reflectance can be determined accurately. Where “reflectance” is used herein, it specifically means “specular reflectance”. The “reflectance” of a surface as used herein is the radiant flux received from the target divided by the radiant flux applied to the target.

Reflectance may also be defined in terms of radiance, and the transformation between these definitions is well known.

Known color and reflectance measurement devices generally have one or more fixed light sources and one or more fixed detectors, and some means of ensuring that the light sources and detectors are at the correct distance from a surface. This requires contact with the surface, which may not always be possible—but without such contact it is difficult to ensure that the proper measurement geometry is maintained.

It is therefore an aim of the present disclosure to provide colour and/or reflectance measurement methods and devices that address one or more of the problems above or at least provides a useful alternative.

### SUMMARY

This specification relates to methods and devices for measuring the color of a surface, and also to measurements of reflectance.

According to a first aspect, there is provided a method of measuring the color of a surface. A device is positioned above the surface. The device comprises an optical sensor and a display screen. The optical sensor measures visible light level in a plurality of spectral channels, each channel having different spectral sensitivity characteristics. The device is positioned such that the sensor measures light reflected from the surface. A plurality of patterns are sequentially displayed on the display screen, each pattern comprising an illuminated region at a different respective distance from the optical sensor. The optical sensor is used to measure light reflected by the surface during display of each pattern. A value is determined for the distance from the optical sensor to the illuminated region for a first local maximum of intensity of the measured light reflected by the surface, the first local maximum being a maximum of the diffuse reflection of the pattern. A location in a color space corresponding to a color of the surface or a reflectance spectrum of the surface is determined based on the visible light level in each spectral channel for the value of the distance corresponding to the first local maximum.

According to a second aspect, there is provided a method of measuring the color of a surface. A device is positioned above the surface. The device comprises an optical sensor and a display screen. The optical sensor measures visible light level. The device is positioned such that the sensor measures light reflected from the surface. A plurality of patterns is sequentially displayed on the display screen, each pattern comprising an illuminated region at a different respective distance from the optical sensor, wherein the plurality of patterns comprises at least two groups of patterns, the illuminated region of each group of patterns being displayed in a different color. The optical sensor is used to measure light reflected by the surface during display of each pattern. A value is determined for the distance from the optical sensor to the illuminated region for a first local maximum of intensity of the measured light reflected by the surface, the first local maximum being a maximum of the diffuse reflection of the pattern. A location in a color space corresponding to a color of the surface or a reflectance spectrum of the surface is determined based on the visible light level for each group of patterns for the value of the distance corresponding to the local maximum.

According to a third aspect, there is provided a system including a device and a controller. The device comprises an optical sensor and a display screen. The optical sensor measures visible light level in a plurality of spectral channels, each channel having different spectral sensitivity characteristics. The controller is configured to:
cause the display screen to sequentially display a plurality of patterns, each pattern comprising an illuminated region at a different respective distance from the sensor;
receive measurements from the optical sensor of light reflected by a surface during display of each pattern;
determine a value of the distance from the optical sensor to the illuminated region for a first local maximum of intensity of the measured light reflected by the surface, the first local maximum being a maximum of the diffuse reflection of the pattern;
determine a location in a color space corresponding to a color of the surface or a reflectance spectrum of the surface based on the visible light level in each spectral channel for the value of the distance corresponding to the first local maximum.

According to a fourth aspect, there is provided a computer program product. The computer program product is for use in a device comprising an optical sensor and a display screen wherein the optical sensor measures visible light level in a plurality of spectral channels, each channel having different spectral sensitivity characteristics. The computer program product comprises:
code for sequentially displaying a plurality of patterns on the display screen, each pattern comprising an illuminated region at a different respective distance from the sensor;
code for measuring, using the optical sensor, light reflected by a surface during display of each pattern;
code for determining the value of the distance from the optical sensor to the illuminated region for a first local maximum of intensity of the measured light reflected by the surface, the first local maximum being a maximum of the diffuse reflection of the pattern;

code for determining a location in a color space corresponding to a color of the surface or a reflectance spectrum of the surface based on the visible light level in each spectral channel for the value of the distance corresponding to the first local maximum.

According to a fifth aspect, there is provided a system including a device and a controller. The device comprises an optical sensor and a display screen. The controller is configured to:
cause the display screen to sequentially display a plurality of patterns, each pattern comprising an illuminated region at a different respective distance from the sensor, wherein the plurality of patterns comprises at least two groups of patterns, the illuminated region of each group of patterns being displayed in a different color;
receive measurements from the optical sensor of light reflected by a surface during display of each pattern;
determine a value of the distance from the optical sensor to the illuminated region for a first local maximum of intensity of the measured light reflected by the surface, the first local maximum being a maximum of the diffuse reflection of the pattern;
determine a location in a color space corresponding to a color of the surface or a reflectance spectrum of the surface based on the visible light level for each group of patterns for the value of the distance corresponding to the first local maximum.

According to a sixth aspect, there is provided a computer program product. The computer program product is for use in a device comprising an optical sensor and a display. The computer program product comprises:
code for sequentially displaying a plurality of patterns on the display screen, each pattern comprising an illuminated region at a different respective distance from the sensor, wherein the plurality of patterns comprises at least two groups of patterns, the illuminated region of each group of patterns being displayed in a different color;
code for measuring, using the optical sensor, light reflected by a surface during display of each pattern;
code for determining the value of the distance from the optical sensor to the illuminated region for a first local maximum of intensity of the measured light reflected by the surface, the first local maximum being a maximum of the diffuse reflection of the pattern;
code for determining a location in a color space corresponding to a color of the surface or a reflectance spectrum of the surface based on the visible light level for each group of patterns for the value of the distance corresponding to the first local maximum.

### BRIEF DESCRIPTION OF THE DRAWINGS

Some examples will now be described by way of example only and with reference to the accompanying drawings, in which:

FIGS. 1A and 1B illustrate measurement geometries for colour measurement;

FIG. 2 shows a device for measuring color and/or reflectance in accordance with the present disclosure;

FIG. 3 illustrates the use of the device of FIG. 2;

FIG. 4 is a flowchart of a method for measuring diffuse and/or specular reflection;

FIGS. 5A to 5E show example patterns displayed on the device of FIG. 2;

FIGS. 6A to 6E are charts showing the light reflected during display of each pattern of FIGS. 5A to 5E;

FIG. 7 is a graph of measurements of light reflected from a surface;

FIG. 8 is a graph showing the emission characteristics of various display screens;

FIGS. 9A and 9B show devices displaying alternative patterns;

FIG. 10 shows a system comprising an alternative device and an external controller.

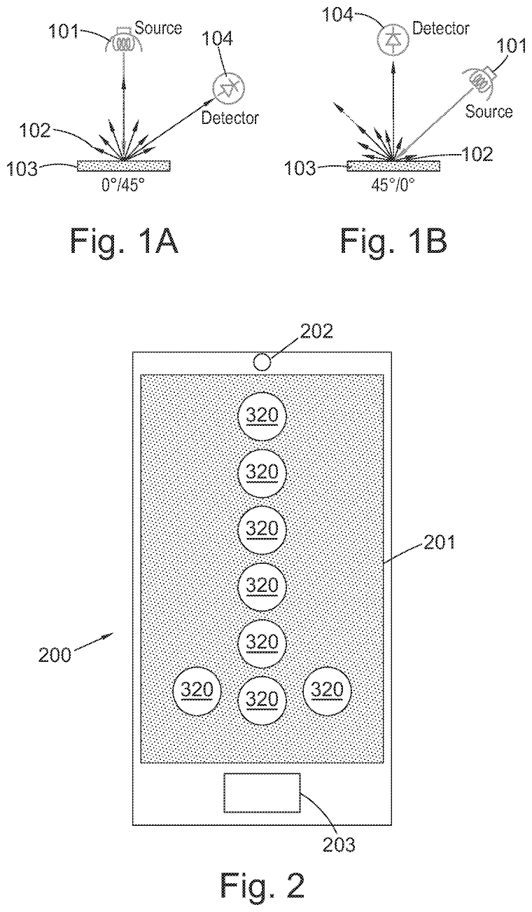

In the figures like elements are indicated by like reference numerals.

### DETAILED DESCRIPTION

There is provided a method of colour and reflectance measurement using a device having a display screen and a detector. The measurement is obtained by showing patterns on the display screen at a plurality of distances from the detector, and then using those measurements to find the peaks in diffuse reflection (for colour measurement) and specular reflection (for reflectance measurement).

Some examples are given in the accompanying figures.

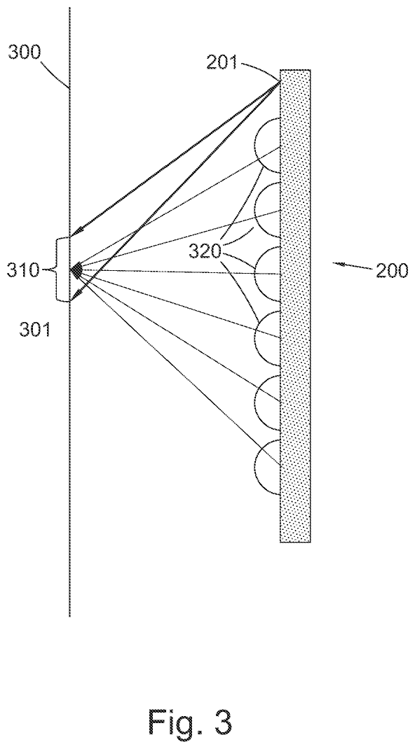

FIG. 2 shows a device 200 having a display screen 201, an optical sensor 202, and a controller 203. FIG. 3 illustrates the device 200 held parallel to a surface 300.

As shown in FIG. 3, the sensor 202 has a field of view 310 which includes a “target spot” 301 on the surface 300. The target spot is defined so as to provide the required sensor angle when the device is held parallel to the surface. Its exact position will depend on the distance of the device from the surface, and the position of the device (i.e. it is a spot identified for convenience of description, rather than a point on the surface with special physical properties). The display screen 201 is positioned such that it illuminates the surface 300, including the target spot 301.

The display screen 201 can be of any type that emits light—e.g. an OLED screen or a backlit e-paper screen.

In general terms, the controller is configured to cause the display screen to display a plurality of patterns 320, one after the other (i.e. sequentially), where each pattern has an illuminated region at a different respective distance from the optical sensor (hereafter the “pattern distance”). The controller receives measurements from the optical sensor during display of each pattern (in particular, measurements of light reflected from the target spot 301 and the surrounding area), and uses these measurements to determine optical properties of the surface 300. The optical properties measured can include the diffuse reflection characteristics of the surface, the color of the surface, and/or the specular reflection characteristics of the surface.

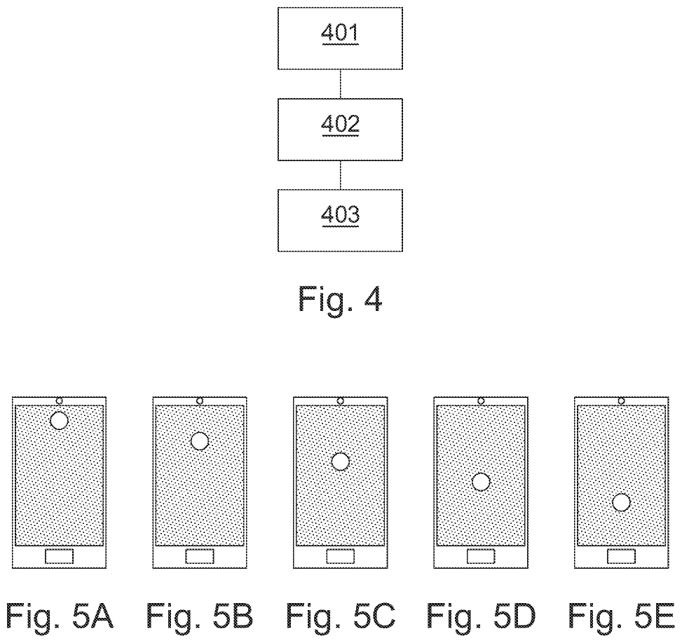

To explain the underlying principles, a method will first be described, with reference to FIG. 4, for the measurement of diffuse and/or specular reflection characteristics generally (i.e. without considering the impact of color or wavelength specific properties).

In step 401, the device 200 is positioned relative to the surface 300, such that the display screen is substantially parallel to the surface, and the sensor measures light reflected from the surface.

In step 402, a plurality of patterns are sequentially displayed on the display screen, as illustrated in FIG. 5A to 5E. Each of the patterns comprises an illuminated circle at a specified “pattern distance” from the sensor, with the rest of the screen being black (i.e. providing minimal illumination). During the display of each pattern, the sensor 201 measures the light reflected from the surface.

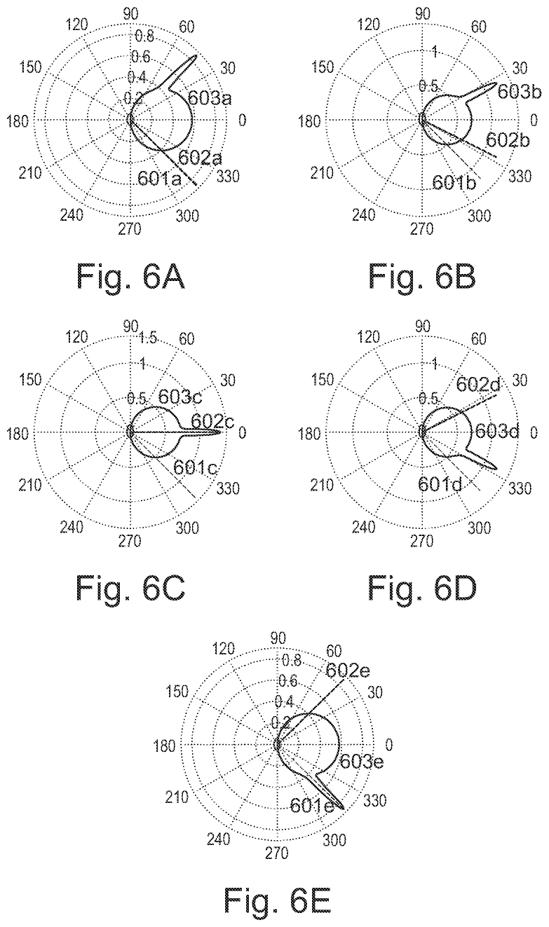

Example reflectance signals during display of each pattern are shown in FIGS. 6A to 6E. In each figure, the sensor angle 601a-e and the illumination angle 602a-e are shown as dotted lines, and the intensity of the reflection 603a-e is shown as a solid line. The value of the measured intensity is the intersection of the sensor angle 601a-e and the reflection intensity 603a-e.

Each of the measurements corresponds to a different measurement geometry, X°/Y°, where X is the illumination angle (the angle between a perpendicular to the surface at the target point, and a line connecting the target point to a representative point of the illuminated region of the display, e.g. a geometric midpoint of the pattern, and Y is the sensor angle e.g. the angle between a perpendicular to the surface and the target point, and a line connecting the target point to the sensor. Y may be fixed for a particular configuration of the device. X may be different for each of the displayed patterns.

In general the device (controller) does not have access to the value of X i.e. of the illumination angle from the pattern to the target point. However the controller 203 does have access to the location of the pattern on the display screen, e.g. because the controller is configured to control display of the pattern, and the measurements received by the detector, and may hence determine other properties of the system.

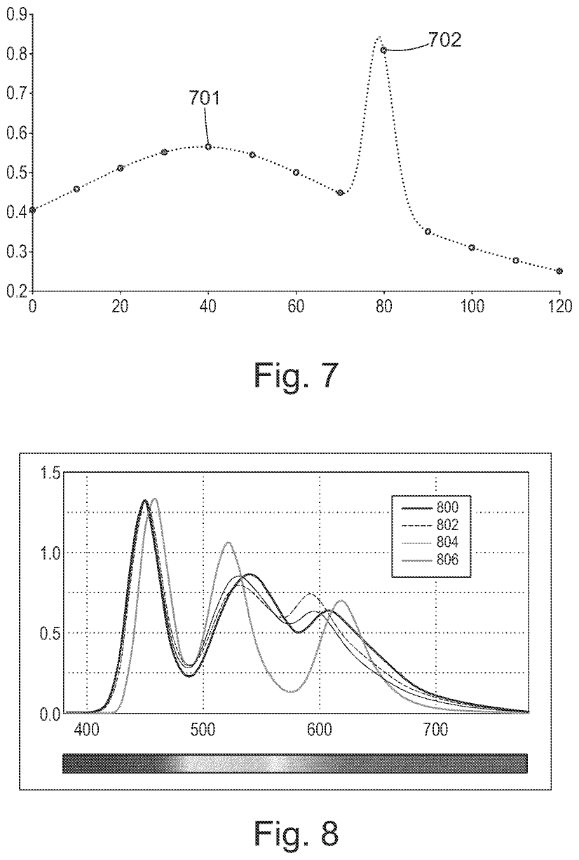

In step 403, the controller 203 determines the pattern distance corresponding to a maximum of the diffuse reflection of the pattern by the surface and/or a maximum of the specular reflection of the pattern by the surface. This is described in more detail below, with reference to FIG. 7.

FIG. 7 shows an example set of measurements for a sensor angle Y of 45 degrees, and a distance between the surface 300 and the display 201 of 40 mm The dots represent the individual sensor measurements (in arbitrary units). As can be seen in the figure, there are two local maxima among the measured points—at 40 mm (701) and 80 mm (702). The maximum 701 can be seen to form part of a smooth curve with most of the other points, and is closer to the sensor than the maximum 702—as such, this maximum can be identified as the maximum associated with the diffuse reflection. The maximum 702 stands out from the other points (indicating that it is on a narrow peak), and is further from the sensor—as such, this maximum can be identified as the maximum associated with the specular reflection.

If a more precise measurement is desired, rather than the actual measurement which happened to come close to the pattern distances for which each reflection is maximised, then the exact maximum of the diffuse reflection can be determined by fitting a curve to the measured points (ignoring any outliers due to the specular reflection). In implementations this curve is approximately sinusoidal. The pattern distance for which the diffuse reflection is maximised corresponds to a Y°/0° geometry—i.e. a geometry in which the pattern is directly above the target point.

The exact maximum of the specular reflection is harder to determine by curve fitting (as there are likely to be few points close to the specular peak). However, the distance between the sensor and the pattern for the specular reflection is generally about twice the distance between the sensor and the pattern for the diffuse reflection (as specular reflection corresponds to a Y°/-Y° geometry), which allows the height of the peak to be estimated based on the known points.

If further accuracy or confirmation is required, then further patterns may be displayed with pattern distances at and close to the calculated values for the diffuse and specular maxima.

Knowledge of the emitted intensity from the display screen, the sensitivity of the sensor, and the maxima determined above allows the reflectance of the surface to be characterised: The positions of the maxima (plus the sensor angle) may be used to determine the distance between the display screen and the surface. This distance may then be used, in combination with the emitted intensity and the measured intensity, to determine the reflectance of the surface for specular reflection and for diffuse reflection, i.e. by comparing the intensity of light received at the sensor to the intensity that would have been received if the surface was a perfect reflector (which is a function of the intensity of the display and the distance travelled by the light).

While the above has considered effectively monochromatic measurement of reflection, similar methods can be used for color measurement. Color measurement is achieved by measuring diffuse reflection for a set of different colors and then mapping the results onto a color space. The set of measured colors may be defined, for example by a color e.g. wavelength of the emitted (illuminating) light, which may be varied; and/or by the spectral channels to which the optical sensor is sensitive.

The wavelength of emitted light may be varied by displaying the patterns on the display screen in at least two colors. Also or instead the optical sensor may be sensitive in at least 2, 3, 4 or more spectral channels, where each channel has a different sensitivity vs wavelength function. The results of the measurements can be transformed to produce a color measurement in a standard color space, or to produce an approximate color spectrum, by standard techniques as known in the art.

The transformation may be performed by a matrix operation, i.e. multiplying a vector representation of the measurements with a matrix representation of the transformation between the measurements and a color space, to obtain a vector representation of the color in that color space. The transformation matrix coefficients will relate to the spectrum of the illumination (i.e. the light emitted by the display screen) and the spectral sensitivity of the sensor. For a color space having w components, and a multi-spectral sensor having n channels, the transformation matrix will be an w×n matrix. Typical color spaces have three components, e.g. the XYZ color space, so where such a color space is used with an RGB sensor, the transformation matrix would be a 3×3 matrix. If a spectral reconstruction is desired, this may be treated as a color space having a large number of components (e.g. 380 nm, 381 nm, etc, up to 780 nm), and the procedure is equivalent.

This transformation may use a preconfigured calibration in the controller, and/or suitable calculations may be performed by the controlled to determine the transformation. Such a calibration may be obtained theoretically, or by measuring surfaces with known color properties and determining the calibration experimentally; the calibration data may then be stored for use by the controller. The color space may be e.g. a CIE color space such as the CIE XYZ color space, or a color space based on the RGB model.

The intensity is measured for each pattern color, sensor channel, or combination of pattern colour and sensor channel, at a pattern distance corresponding to the maximum of diffuse reflection. This may be the maximum actually measured point, or may be an interpolation of the measured points to obtain the “true” maximum of diffuse reflection. he set of measured intensities at maximum diffuse reflection are then transformed to give a color measurement, e.g. in a standard color space, or an estimate of the reflectance spectrum of the surface.

The sensor may be e.g. any of: a three channel sensor (e.g. a sensor which provides direct output in a three-channel color space, such as an RGB or XYZ sensor); a camera chip, such as a CCD (to measure the correct region of the surface, the measurement may use only a subset of the pixels of the camera chip); a multi-spectral sensor; and a photodetector array, wherein the photodetectors in the array are configured to measure light in each of a plurality of spectral channels.

The display may be e.g. any of: an OLED display; a backlit liquid crystal display; and any other light emitting display e.g. which can display arbitrary patterns.

The transformation from the sensor measurements to the color may be based in part on a calibration based on the wavelength-dependent sensitivity of the sensor and/or the wavelength dependent intensity of light emitted by the display (i.e. the spectral characteristics of “white” as emitted by the display). Example wavelength dependent intensities for “white” on common display screens are shown in FIG. 8.

An additional backlight compensation step may be performed. This may comprise taking measurements from the sensor when the device is in position but no pattern is displayed on the display screen (e.g. the screen is black), and subtracting these measurements from all other measurements made by the sensor.

The sensor angle may be 45 degrees (i.e. to give a measurement geometry which matches the generally used standards for color measurement), but other geometries may be used (e.g. to allow the method to be performed with a broader range of hardware).

The device may be provided as an integral unit (e.g. having the display and the sensor on the same unit, such as a smartphone with a front facing camera), or the sensor may be provided as a module to be attached to a second module comprising the display.

There are various possibilities for the pattern which is used to illuminate the target. The simplest is a circle as shown in FIGS. 5A to 5E, with the circles being of a consistent size, and located on a single line extending through the sensor, in this case, the midline of the display. The radius of the circles, or in general, the size of the illuminated area in each pattern, is a balance between the illumination of the surface, and how closely the illumination is to the ideal “point source”-like behaviour. Larger patterns give greater illumination; smaller patterns give results closer to a point source.

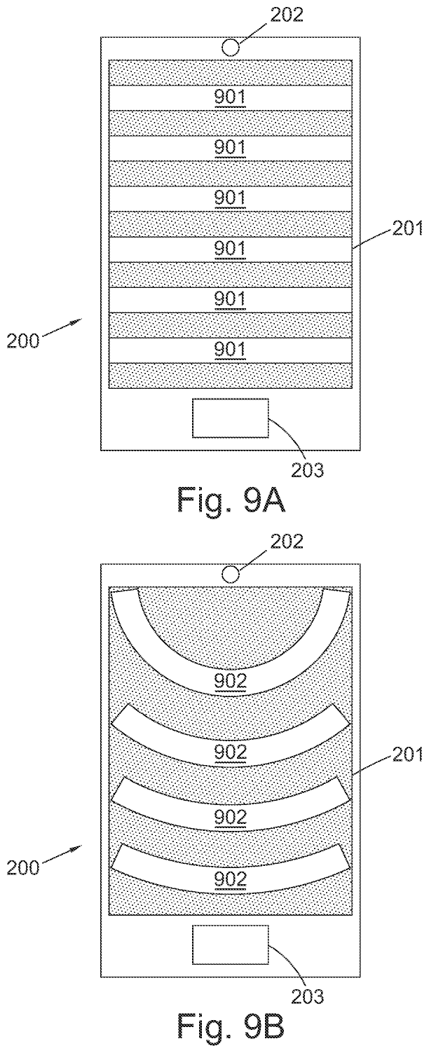

The use of illumination areas within the patterns with shapes other than circles can provide a better balance between these factors. FIGS. 9A and 9B show other options for the pattern; each shows all of the patterns at once, for convenience, although these are in practice displayed sequentially (as in FIGS. 5A to E). For example, if each pattern is a line 901 perpendicular to the line extending through the sensor, e.g. horizontal lines on the display, as shown in FIG. 9A, then the total area of the pattern is larger for a given span of illumination angles of the pattern. The span of illumination angles is the difference between the illumination angle for the part of the pattern closest to the sensor, and the illumination angle for the part of the pattern furthest from the sensor. Further improvement in that regard can be obtained by defining the pattern to be an arc 902 centred on the sensor (as shown in FIG. 9B), but in this case the pattern area is different depending on the pattern distance.

Additionally, by comparing the measurements received from patterns either side of a straight line passing through the sensor, the tilt of the device may be determined. If the device is parallel to the surface, then the measurements made by the sensor should be the same for a first pattern which is located at a first pattern distance from the sensor, and is located on the left side of a straight line passing through the sensor, and for a second pattern which is located at the same pattern distance but on the right side of the straight line passing through the sensor—where the straight line passing through the sensor passes directly over the target point. If the measurement is greater for the first pattern than for the second pattern, then this indicates that the left side of the device is closer to the surface than the right side, and vice versa. To obtain increased accuracy for this tilt measurement it may be performed at the pattern distance corresponding to the maximum specular reflection (as this will show the greatest change in measured intensity due to tilt), but this is not required.

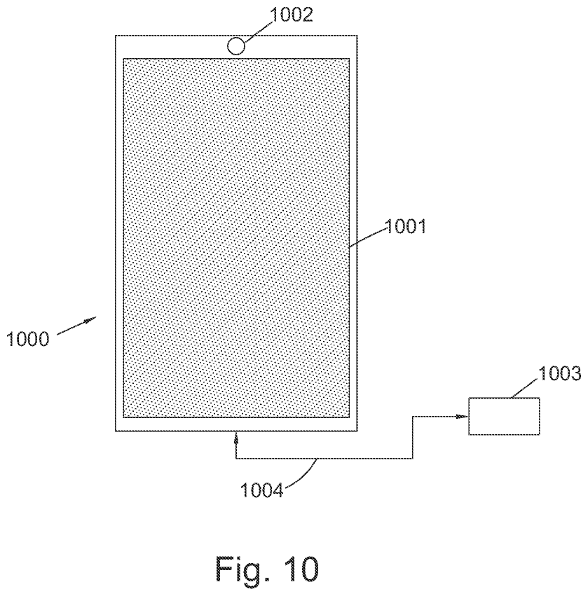

While the controller has been described above as being integral with the device, this need not be the case. FIG. 10 shows an alternative arrangement where the device 1000 comprises a display screen 1001 and a sensor 1002. A separate controller 1003 is connected to the device via a wired or wireless data connection 1004. For example, the device may be a peripheral which is connected to a computer which acts as the controller, As a further alternative (not illustrated), the role of the controller may be shared between a first controller on the device, and a second, external controller. For example, the second controller may be a cloud server which performs the determination of the color from the sensor measurements, with the control of the display being handled by a first controller on the device.

In general, a system comprises a device (200, 1000) having a display screen (201, 1001) and a sensor (202, 1002), and also comprises a controller which may be a part of the device (203), external to the device (1003), or distributed between the device and other entities (not shown in figures).

The examples of the above disclosure can be employed in many different applications including paint or dye matching, color reproduction in computer generated imagery, or characterising materials, for example, in the paint industry, and other industries.

### LIST OF REFERENCE NUMERALS

101 light source

102 point on surface 103

103 surface

104 detector

200 device

201 display screen

202 optical sensor

203 controller

300 surface

301 target spot on surface

310 field of view of sensor 202

320 patterns on display 201

401 first method step

402 second method step

403 third method step

In FIG. 6, the reference numerals are followed by a letter from a to e, with each letter denoting the respective element in FIGS. 6A to 6E respectively.

601a-e sensor angle

602a-e illumination angle

603a-e intensity of reflection

701 peak measurement corresponding to diffuse reflection

702 peak measurement corresponding to specular reflection

901 pattern comprising line across display screen

902 pattern comprising arc on display screen, centered on sensor

1000 alternative device

1001 display screen

1002 optical sensor

1003 controller external to device 1000

1004 connection between controller 1003 and device 1000

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Also, while “intensity” has generally been used as a measure of brightness of light, it will be appreciated that similar quantities (e.g. power, radiance, etc) may be used instead, as would be apparent to the person skilled in the art.

Although the disclosure has been described in terms of examples as set forth above, it should be understood that these are illustrative only and that the claims are not limited to those examples. Those skilled in the art will be able to make modifications and alternatives in view of the disclosure which are contemplated as falling within the scope of the appended claims. Each feature disclosed or illustrated in the present specification may be incorporated in any practical realisation of the concepts therein, whether alone or in any appropriate combination with any other feature disclosed or illustrated herein.

1. A method of measuring the color of a surface, the method comprising:
positioning a device above the surface, the device comprising an optical sensor and a display screen, wherein the optical sensor measures visible light level in a plurality of spectral channels, each channel having different spectral sensitivity characteristics, the device being positioned such that the sensor measures light reflected from the surface;
sequentially displaying a plurality of patterns on the display screen, each pattern comprising an illuminated region at a different respective distance from the optical sensor;
measuring, using the optical sensor, light reflected by the surface during display of each pattern;
determining a value of the distance from the optical sensor to the illuminated region for a first local maximum of intensity of the measured light reflected by the surface, the first local maximum being a maximum of the diffuse reflection of the pattern;
determining a location in a color space corresponding to a color of the surface or a reflectance spectrum of the surface based on the visible light level in each spectral channel for the value of the distance corresponding to the first local maximum.

2. A method according to claim 1, wherein the value of the distance corresponding to the first local maximum is determined for one of:
measurements from a single channel of the plurality of spectral channels; and
an average of measurements from each channel of the plurality of spectral channels.

3. A method according to claim 1, wherein the illuminated region of each pattern is white.

4. A method according to preceding claim 1, wherein the plurality of patterns comprises at least two groups of patterns, and wherein the illuminated region of each group of patterns is displayed in a different color.

5. A method of measuring the color of a surface, the method comprising:
positioning a device above the surface, the device comprising an optical sensor and a display screen, wherein the optical sensor measures visible light level, the device being positioned such that the sensor measures light reflected from the surface;
sequentially displaying a plurality of patterns on the display screen, each pattern comprising an illuminated region at a different respective distance from the optical sensor, wherein the plurality of patterns comprises at least two groups of patterns, the illuminated region of each group of patterns being displayed in a different color;
measuring, using the optical sensor, light reflected by the surface during display of each pattern;
determining a value of the distance from the optical sensor to the illuminated region for a first local maximum of intensity of the measured light reflected by the surface, the first local maximum being a maximum of the diffuse reflection of the pattern;
determining a location in a color space corresponding to a color of the surface or a reflectance spectrum of the surface based on the visible light level for each group of patterns for the value of the distance corresponding to the local maximum.

6. A method according to claim 5, wherein the first local maximum is a local maximum point of an curve of intensity against the value of the distance, such that the curve fits the measurements, and wherein the location in color space is determined by interpolating the measurements to obtain further measurements at the first local maximum.

7. A method according to claim 5, further comprising obtaining a background measurement by measuring, using the optical sensor, light reflected by the surface when no pattern is displayed, and subtracting the background measurement for each other measurement of the sensor.

8. A method according to claim 5, wherein the optical sensor is configured to measure light reflected at an angle of 45 degrees from the surface.

9. A method according to claim 5, wherein the sensor is configured to measure visible light level in a plurality of spectral channels, and comprises any one or more of:
a photodetector array, the photodetector array comprising photodetectors being sensitive to each of the spectral channels;
a multi-spectral optical sensor;
a three channel color sensor;
a camera comprising a CCD or CMOS; and
a camera comprising a CCD or CMOS, wherein only a subset of pixels of the CCD or CMOS are used to obtain the measurement.

10. A method according to claim 5, wherein the illuminated region of each pattern is a disc against a black background.

11. A method according to claim 1, wherein the illuminated region of each pattern is a straight line across the display screen, against a black background.

12. A method according to claim 1, wherein the illuminated region of each pattern is an arc centered on the sensor, against a black background.

13. A method according to claim 1, further comprising determining a reflectance of the surface based on a second local maximum of the reflected light, wherein the second local maximum corresponds to a value of the distance which is greater than the value of the distance of the first local maximum.

14. A method according to claim 13, and comprising determining a distance between the device and the surface based on the value of the distance corresponding to the first local maximum, and determining the reflectance of the surface based on the distance between the device and the surface and the measurements made by the sensor at the pattern distance corresponding to the second local maximum.

15. A method according to claim 1, wherein the plurality of patterns consists of:
a first set of patterns, wherein each pattern in the first set is a translation of the other patterns in the first set along a straight line from the sensor;
a second set of patterns, wherein the second set of patterns are located either side of the straight line from the sensor;
using measurements of reflected light of the second set of patterns to determine a tilt of the device relative to the surface.

16. A system comprising:
a device comprising:
an optical sensor configured to measure visible light level in a plurality of spectral channels, each channel having different spectral sensitivity characteristics; and
a display screen; and
a controller configured to:
command the display screen to sequentially display a plurality of patterns, each pattern comprising an illuminated region at a different respective distance from the sensor;
receive measurements from the optical sensor of light reflected by a surface during display of each pattern;
determine a value of the distance from the optical sensor to the illuminated region for a first local maximum of intensity of the measured light reflected by the surface, the first local maximum being a maximum of the diffuse reflection of the pattern; and
determine a location in a color space corresponding to a color of the surface or a reflectance spectrum of the surface based on the visible light level in each spectral channel for the value of the distance corresponding to the first local maximum.

17. (canceled)

18. (canceled)

19. (canceled)
